(19) United States
(12) Patent Application Publication
(10) Pub. No.: US 2007/0040969 A1
(43) Pub. Date: Feb. 22, 2007

(54) LIQUID CRYSTAL DISPLAY DEVICE

(76) Inventors: Norihiro Yoshida, Fukaya-shi (JP); Takeshi Yamaguchi, Kumagaya-shi (JP); Yasushi Kawata, Ageo-shi (JP); Yuuzo Hisatake, Fukaya-shi (JP); Kisako Ninomiya, Fukaya-shi (JP); Akio Murayama, Fukaya-shi (JP); Chigusa Tago, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/461,197

(22) Filed: Jul. 31, 2006

(30) Foreign Application Priority Data
Aug. 18, 2005 (JP) 2005-237616
Aug. 18, 2005 (JP) 2005-237622

(51) Int. Cl. G02F 1/1335

(52) U.S. Cl. 349/114

(57) ABSTRACT

A liquid crystal display device comprises a first electrode substrate, a second electrode substrate arranged opposite to the first electrode substrate with a gap therebetween, a liquid crystal layer held between the first and second electrode substrates, and including transmissive display sections and reflective display sections adjacent to the transmissive display sections, a linear boundary being defined between each transmissive display section and each reflective display section, orientation of liquid crystal molecules in the transmissive display sections and the reflective display sections being controlled in accordance with voltages applied to the liquid crystal layer by the first and second electrode substrates, and a control section which controls an electric field generated by the applied voltages to set, substantially parallel to the boundary, the orientation of those of the liquid crystal molecules which exist in the transmissive display sections near the boundary.

### CROSS-REFERENCE TO RELATED APPLICATIONS

This application is based upon and claims the benefit of priority from prior Japanese Patent Applications No. 2005-237616, filed Aug. 18, 2005; and No. 2005-237622, filed Aug. 18, 2005, the entire contents of both of which are incorporated herein by reference.

### BACKGROUND OF THE INVENTION

1. Field of the Invention

The present invention relates to a liquid crystal display device, and more particularly to a transflective liquid crystal display device.

2. Description of the Related Art

In recent years, liquid crystal display devices are used as display devices. Liquid crystal display devices emit no light, different from cathode ray tubes (CRTs) and electroluminescence (EL) devices. Accordingly, the liquid crystal display devices are transmissive type devices that display images using a backlight unit. However, the power consumption of the backlight unit is 50% or more of that of the entire device. In view of this, for portable information devices that are often used outside or carried, reflective type liquid crystal display devices capable of displaying images utilizing only ambient light have been developed. The reflective type liquid crystal display devices are disadvantageous in that when the ambient is dark, the intensity of reflective light used for display is low, and hence the visibility is extremely low. In contrast, the transmissive type liquid crystal display devices are disadvantageous in that in, for example, fine weathers in which the ambient is very bright, the visibility is low.

To overcome the above problems, transflective liquid crystal display devices have been developed in which each pixel includes a reflective display section and transmissive display section. Jpn. Pat. Appln. KOKAI Publication No. 2003-114419, for example, discloses such a transflective liquid crystal display device. In this device, reflective display and transmissive display are realized by employing different liquid crystal layer thicknesses.

The disclosed transflective liquid crystal display device functions, in a dark place, as a transmissive type liquid crystal display device that displays images by selectively transmitting backlight through the transmissive display section of each pixel. In contrast, in a bright place, the device functions as a reflective type liquid crystal display device in which ambient light is selectively reflected by the reflective display sections of pixels. This structure enables the power consumption to be significantly reduced.

It is sufficient if the display mode employed in liquid crystal display devices is used for displaying changes in the alignment of liquid crystal molecules. For instance, display modes utilizing a polarizing plate, such as twisted nematic (TN) mode and super twisted nematic (STN) mode, can be employed. In recent years, liquid crystal display devices utilizing a phase-transition-type guest-host mode, which use no polarizing plate and hence can realize a bright display, have been developed. Concerning devices of this type, see Jpn. Pat. Appln. KOKAI Publication No. 4-75022, for example.

In multi-domain VAN (MVA) mode, which utilizes a vertical alignment process, liquid crystal molecules near the alignment film surface are perpendicular to the substrate, and the index of birefringence of the liquid crystal layer is substantially zero. Accordingly, liquid crystal display devices of the MVA mode can display clear black and hence images of high contrast. Further, the MVA mode facilitates designing for compensating the viewing angle, realization of a wide viewing angle, and elimination of a conventional rubbing alignment process, which may cause a defect such as electrostatic breakdown. In light of the above, attention is now paid to the MVA mode.

However, if the MVA mode is employed in the above-mentioned transflective liquid crystal display device, complex elastic energy occurs because of the direction of an electric field applied to the liquid crystal layer, and because of the boundary configuration of the liquid crystal layer. This makes it difficult to acquire guidelines concerning the alignment state of liquid crystal molecules set in consideration of the arrangement of ribbed projections and slits, etc. Accordingly, liquid crystal molecules may have different alignments in different domains. Namely, it is difficult to form, in each pixel, a plurality of domains in which liquid crystal molecules are aligned uniformly.

### BRIEF SUMMARY OF THE INVENTION

The present invention has been made in view of the foregoing. An object of the invention is to provide a liquid crystal display device that has a wide viewing angle obtained by virtue of reliable domain division, is free from a reduction in light transmittance due to, for example, different alignments of liquid crystal molecules, and can realize high-quality transmissive display and reflective display.

An another object of the invention to provide a liquid crystal display device of a wide viewing angle capable of realizing high-quality display.

To satisfy the objects, according to an aspect of the invention, there is provided a liquid crystal display device comprising:
a first electrode substrate;
a second electrode substrate arranged opposite to the first electrode substrate with a gap therebetween;
a liquid crystal layer held between the first and second electrode substrates, and including transmissive display sections and reflective display sections adjacent to the transmissive display sections, a linear boundary being defined between each transmissive display section and each reflective display section, orientation of liquid crystal molecules in the transmissive display sections and the reflective display sections being controlled in accordance with voltages applied to the liquid crystal layer by the first and second electrode substrates; and
a control section which controls an electric field generated by the applied voltages to set, substantially parallel to the boundary, the orientation of the liquid crystal molecules which exist in the transmissive display sections near the boundary.

According to another aspect of the invention, there is provided a liquid crystal display device comprising:
a first electrode substrate;
a second electrode substrate arranged opposite to the first electrode substrate with a gap therebetween;
a liquid crystal layer held between the first and second electrode substrates and including transmissive display sections and reflective display sections adjacent to the transmissive display sections, orientation of liquid crystal molecules in the transmissive display sections and the reflective display sections being controlled in accordance with voltages applied to the liquid crystal layer by the first and second electrode substrates;
projecting portions provided on the second electrode substrate at positions corresponding to the reflective display sections, and projecting toward the first electrode substrate to make the reflective display sections thinner than the transmissive display sections; and
projections provided on the second electrode substrate at positions corresponding to the transmissive display sections, and projecting toward the first electrode substrate to control the orientation of the liquid crystal molecules of the transmissive display sections, each projection including an end located at a gap from an edge of the projecting portion adjacent to the transmissive display section.

According to another aspect of the invention, there is provided a liquid crystal display device comprising:
a first electrode substrate;
a second electrode substrate arranged opposite to the first electrode substrate with a gap therebetween;
a liquid crystal layer held between the first and second electrode substrates and including transmissive display sections and reflective display sections adjacent to the transmissive display sections, orientation of liquid crystal molecules in the transmissive display sections and the reflective display sections being controlled in accordance with voltages applied to the liquid crystal layer by the first and second electrode substrates;
projecting portions provided on the second electrode substrate at positions corresponding to the reflective display sections, and projecting toward the first electrode substrate to make the reflective display sections thinner than the transmissive display sections; and
projections provided on the second electrode substrate at positions corresponding to the transmissive display sections, and projecting toward the first electrode substrate to control the orientation of the liquid crystal molecules of the transmissive display sections, each projection including an end aligned with an edge of the projecting portion adjacent to the transmissive display section.

Additional objects and advantages of the invention will be set forth in the description which follows, and in part will be obvious from the description, or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view illustrating a structure example of a liquid crystal display panel incorporated in a liquid crystal display device according to the first embodiment of the invention;

FIG. 2 is a view illustrating a structure example of the liquid crystal display panel of FIG. 1;

FIG. 3 is a sectional view illustrating the structure example of the liquid crystal display panel of FIG. 1;

FIG. 4 is a view illustrating a structure example of a transmissive display section and a reflective display section incorporated in the liquid crystal display device;

FIG. 5 is a sectional view taken along line V-V in FIG. 4, illustrating the transmissive display section and reflective display section;

FIG. 6 is a view useful in explaining the effect of the transmissive display section and reflective display section incorporated in the liquid crystal display device shown in FIGS. 4 and 5;

FIG. 7 is a sectional view taken along line VII-VII in FIG. 6, illustrating the transmissive display section and reflective display section;

FIG. 8 is a view illustrating a structure example of a transmissive display section and reflective display section incorporated in a liquid crystal display device according to a second embodiment of the invention;

FIG. 9 is a view illustrating a structure example of a transmissive display section and reflective display section incorporated in a liquid crystal display device according to a third embodiment of the invention;

FIG. 10 is a view illustrating a structure example of a transmissive display section and reflective display section incorporated in a liquid crystal display device according to a fourth embodiment of the invention;

FIG. 11 is a view illustrating a structure example of a transmissive display section and reflective display section incorporated in a liquid crystal display device according to a fifth embodiment of the invention;

FIG. 12 is a table illustrating estimation results of the liquid crystal display devices according to the first to fifth embodiments;

FIG. 13 is a sectional view illustrating a liquid crystal display device according to a sixth embodiment of the invention;

FIG. 14 is a plan view illustrating counter substrate incorporated in example 1 of the liquid crystal display device of FIG. 13;

FIG. 15 is a sectional view taken along line XV-XV of FIG. 14, illustrating the counter substrate;

FIG. 16 is a sectional view taken along line XVI-XVI of FIG. 14, illustrating the liquid crystal display device;

FIG. 17 is a sectional view counter substrate incorporated in example 2 of the liquid crystal display device of FIG. 13;

FIG. 18 is a sectional view counter substrate incorporated in example 3 of the liquid crystal display device of FIG. 13;

FIG. 19 is a sectional view counter substrate incorporated in example 4 of the liquid crystal display device of FIG. 13; and

FIG. 20 is a table illustrating the existence or nonexistence of image sticking in relation to the distance between a projecting portion and a projection that are incorporated in the counter substrate of the liquid crystal display device of FIG. 13.

### DETAILED DESCRIPTION OF THE INVENTION

Liquid crystal display device according to a first embodiment of the invention will be described with reference to the accompanying drawings. The liquid crystal display device is, for example, an active-matrix-type one, and comprises a liquid crystal display panel 100.

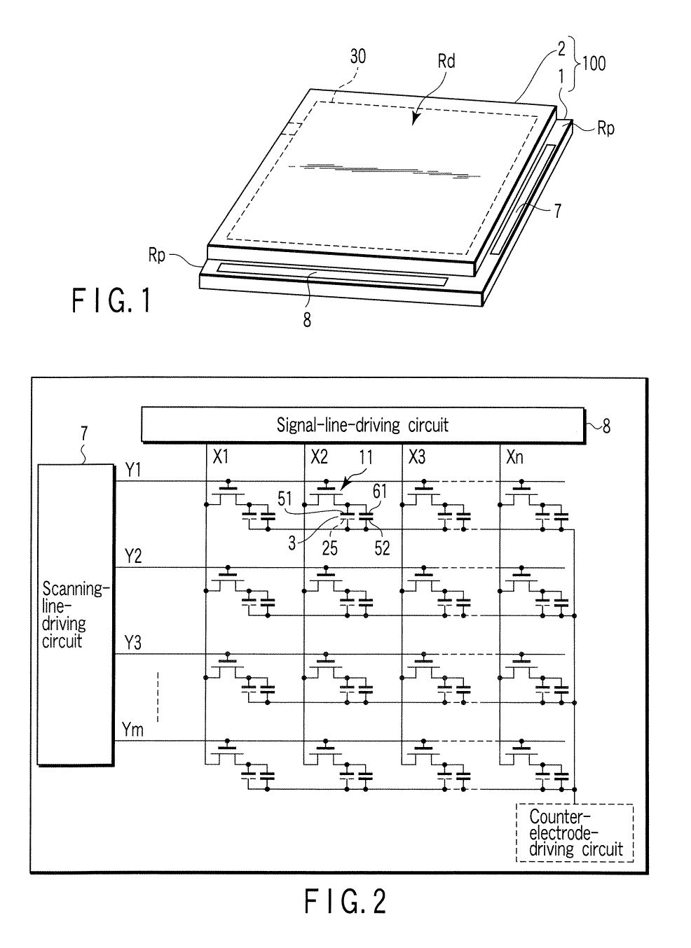

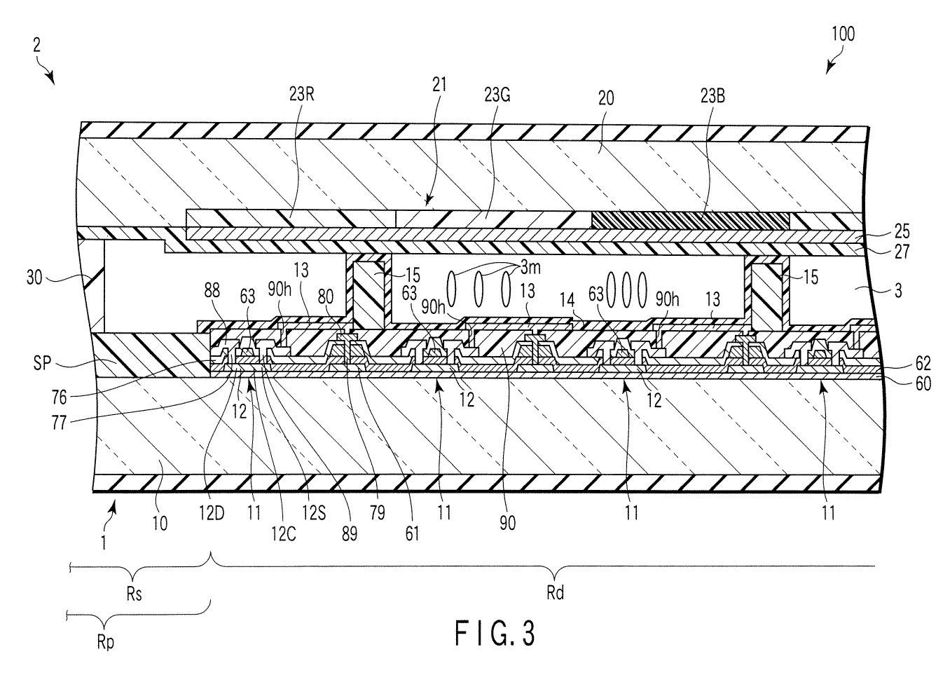

As shown in FIG. 1, the liquid crystal display panel 100 comprises an array substrate 1, which serves as a first electrode substrate, a counter substrate 2 arranged opposite to the array substrate 1 with a predetermind gap therebetween, which serves as a second electrode substrate and a liquid crystal layer 3 (see FIG. 3) held between the array substrate 1 and counter substrate 2. The array substrate 1 and counter substrate 2 are bonded together with a sealing member (outer edge sealing member) 30 provided in the edge portions of both of the substrates. In the liquid crystal display panel 100 constructed as the above, a display region Rd for displaying images is defined within the region surrounded by the sealing member 30. A peripheral region Rp around the periphery of the display region Rd is provided outside the sealing member 30, and includes a frame-shaped shade region Rs (see FIG. 3) provided outside the sealing member 30.

As shown in FIG. 2, the array substrate 1 includes, in the display region Rd, m×n pixel electrodes 13 arranged in a matrix, m scanning lines Y1 to Ym provided in the row direction of the pixel electrodes 13, n signal lines X1 to Xn provided in the column direction of the pixel electrodes 13, and m×n thin-film transistors, i.e., TFTs 11, provided near the intersections of the scanning lines Y1 to Ym and the signal lines X1 to Xn and serving as switching elements.

Further, the array substrate 1 includes, in the peripheral region Rp, a scanning-line-driving circuit 7 for driving the scanning lines Y1 to Ym, and a signal-line-driving circuit 8 for driving the signal lines X1 to Xn.

As shown in FIG. 3, the array substrate 1 of the liquid crystal display panel 100 comprises, in the display region Rd, a glass substrate 10 as a transparent insulating substrate, an insulation layer 90 formed on the glass substrate 10, a plurality of pixel electrodes 13 provided on the insulation layer 90 and corresponding to the respective pixels, a plurality of columnar spacers 15 provided on the insulation layer 90, and an alignment film 14 covering the pixel electrodes 13. The insulation layer 90 covers the display region Rd that contains switching elements, i.e., TFTs 11, corresponding to the pixels arranged in a matrix. Further, the array substrate 1 includes, in the peripheral region Rp, a shade layer SP that surrounds the display region Rd in the shade region Rs of the transmissive substrate.

The pixel electrodes 13 are formed of a transmissive conductive material, such as indium tin oxide (ITO), and connected to the respective TFTs 11 via respective through holes 90h formed through the insulation layer 90. The TFTs 11 are connected to the scanning lines formed in the row direction of the pixel electrodes 13, and to the signal lines formed in the column direction of the pixel electrodes 13. When a driving voltage is applied to the TFTs through the scanning lines, the TFTs become conductive and apply a signal voltage to the pixel electrodes 13.

The array substrate 1 also includes auxiliary capacitance electrodes 61 having the same potential as the pixel electrodes 13 and opposing them via a gate insulation film 62 for forming auxiliary capacitances, and includes auxiliary capacitance lines 52 set at a preset potential.

The signal lines X are substantially perpendicular to the scanning lines Y and auxiliary capacitance lines 52, with an interlayer insulation film 76 interposed therebetween. The auxiliary capacitance lines 52 are formed of the same material in the same layer as the scanning lines Y, and arranged substantially parallel to the scanning lines Y. Some of the auxiliary capacitance lines 52 oppose the auxiliary capacitance electrodes 61 via the gate insulation film 62. The auxiliary capacitance electrodes 61 are formed of impurity-doped polysilicon film.

The wiring elements, such as the signal lines X, scanning lines Y and auxiliary capacitance lines 52, etc., are formed of a low-resistance material having a shade property, such as aluminum, an alloy of molybdenum and tungsten, etc. In this embodiment, the scanning lines Y and auxiliary capacitance lines 52 are formed of the alloy of molybdenum and tungsten, and the signal lines X are mainly formed of aluminum.

The TFT 11 has a semiconductor layer 12 formed of the same polysilicon film as the auxiliary capacitance electrodes 61. The semiconductor layer 12 is provided on an undercoating layer 60 that is provided on the glass substrate, and includes a drain region 12D and source region 12S formed by doping the opposite end portions of a channel region 12C with an impurity. The TFT includes a gate electrode 63 that is formed as one body with the corresponding scanning line Y, and opposes the semiconductor layer 12 with the gate insulation film 62 interposed therebetween.

The drain electrode 88 of the TFT 11 is formed as one body with the signal line X, and is electrically connected to the drain region 12D of the semiconductor layer 12 via a contact hole 77 formed through the gate insulation film 62 and interlayer insulation film 76. The source electrode 89 of the TFT 11 is electrically connected to the source region 12S of the semiconductor layer 12 via another contact hole formed through the gate insulation film 62 and interlayer insulation film 76.

The insulation layer 90 is provided on the interlayer insulation layer 76 of the array substrate 1. The pixel electrodes 13 are provided on the insulation layer 90 and electrically connected to the source electrodes 89 of the TFTs 11 via through-holes 90h.

The auxiliary capacitance electrode 61 is electrically connected to a contact electrode 80, formed of the same material as the signal line X, via a contact hole 79 formed through the gate insulation film 62 and interlayer insulation film 76. As a result, the source electrode 89 of the TFT 11, pixel electrode 13 and auxiliary capacitance electrode 61 are set at the same potential.

Further, as shown in FIG. 3, the liquid crystal display panel 100 includes the columnar spacers 15 that define a preset gap between the array substrate 1 and the counter substrate 2. The alignment film 14 orients the liquid crystal molecules, contained in the liquid crystal layer 3, in a direction substantially perpendicular to the array substrate 1.

The counter substrate 2 comprises a color filter 21 provided on the glass substrate 20 as a transparent insulating substrate, a counter electrode 25, and an alignment film 27 covering the counter electrode 25. The color filter 21 has red coloring layers 23R, green coloring layers 23G and blue coloring layers 23B. The counter electrode 25 is formed of a light-transmission conductive member of, for example, ITO that opposes all the pixel electrodes 13 of the array substrate 1. The alignment film 27 orients the liquid crystal molecules, contained in the liquid crystal layer 3, in a direction substantially perpendicular to the counter substrate 2.

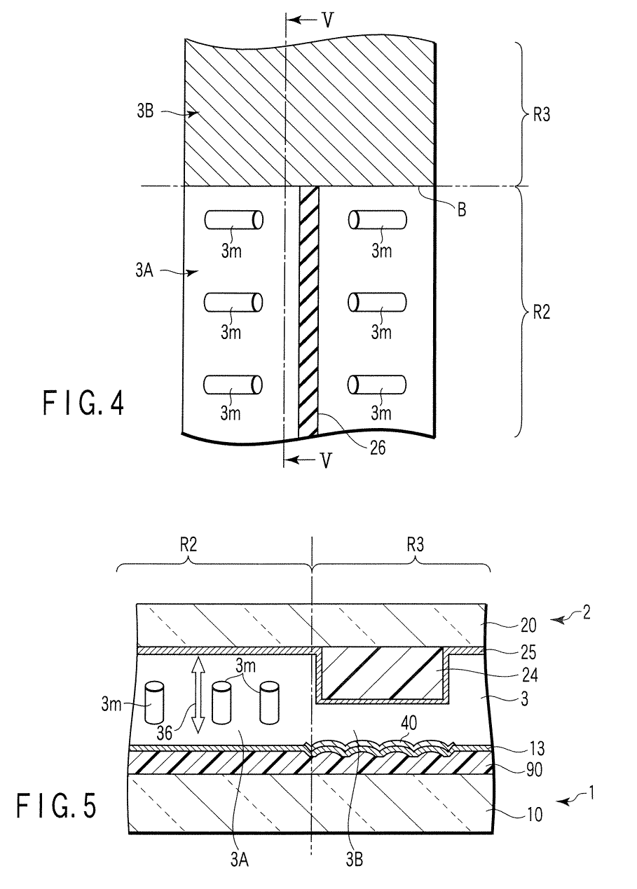

The above-described liquid crystal display device and the pixel structure of the device will be described in detail. As shown in FIGS. 4 and 5, the liquid crystal display panel 100 comprises a plurality of transmissive regions R2 and reflective regions R3. The liquid crystal layer 3 includes a plurality of transmissive display sections 3A and reflective display sections 3B. The transmissive display sections 3A and reflective display sections 3B are superposed upon the transmissive regions R2 and reflective regions R3, respectively.

The pixel electrode 13 comprises a transmissive electrode 41 provided on the insulation layer 90, and a reflective electrode 40 provided on the transmissive electrode 41 and corresponding to the reflective display section 3B. The reflective electrode 40 has an uneven surface corresponding to the uneven surfaces of the transmissive electrode 41 and insulation layer 90 on the glass substrate 10.

In the reflective region R3, the reflective electrode 40 reflects, to the counter substrate 2 side, the light guided through the counter substrate 2. In the transmissive region R2, the transmissive electrode 41 transmits, to the counter substrate 2 side, the light guided through the array substrate 1. Thus, the liquid crystal display panel 100 realizes transmissive display and reflective display.

To set the transmissive display sections 3A and reflective display sections 3B to different thicknesses, the counter substrate 2 has projecting portions 24 below the counter electrode 25 opposing the reflective display sections 3B. Each projecting portion 24 is formed of a transmissive resin layer. Each projecting portion 24 makes the thickness of the reflective display section 3B substantially half that of the transmissive display section 3A.

As shown in FIG. 4, the boundary B between the transmissive display sections 3A and reflective display sections 3B extends substantially linearly in the direction that is substantially perpendicular to the long side of the pixel electrode 13. The counter substrate 2 has ribbed projections (insulating structure) 26 each serving as a control section for controlling the electric field generated at the transmissive display section 3A of the liquid crystal layer 3. Each projection 26 is provided on the counter electrode 25, extending in the direction substantially perpendicular to the boundary B.

The projection 26 controls the electric field generated at the liquid crystal layer 3 so as to cause the orientation of the liquid crystal molecules 3m existing in the transmissive display section 3A near the boundary B to be substantially parallel to the boundary B in the surfaces of the array substrate 1 and counter substrate 2. Namely, when a voltage is applied to the liquid crystal layer 3, the projection 26 causes a line of electric force 36 to occur in the surfaces of the array substrate 1 and counter substrate 2 in the direction substantially parallel to the boundary B, as indicated by the arrow in FIG. 5. At this time, the liquid crystal molecules 3m are oriented substantially perpendicularly to the line of electric force 36, i.e., they are arranged with their directors set substantially parallel to the boundary B.

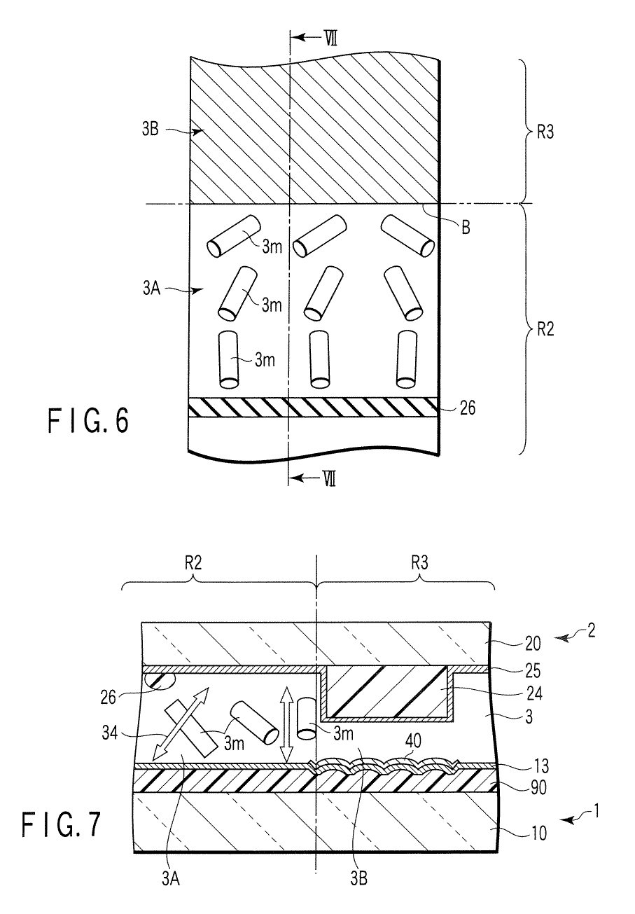

For instance, in the cases shown in FIGS. 6 and 7, the orientation of the liquid crystal molecules 3m exiting in the transmissive display section 3A near the boundary B is substantially perpendicular to the boundary B. However, a line of electric force 34 tilting with respect to the normal line of the substrate occurs due to the projection 26. Although liquid crystal molecules tilt in a preset direction so that their anisotropic dielectric constant is aligned along the tilted line of electric force 34, the range of tilting is only from the projection 26 to the position about 10 μm away. The molecules existing away from the projection 26 are oriented to minimize their elastic energy.

In contrast, the liquid crystal molecules 3m existing near the boundary B tend to be substantially parallel to the boundary B. As a result, torsion in orientation may occur in a certain region between the boundary B and projection 26, and the liquid crystal molecules in the region may not be oriented at a desired angle. In this case, rightward torsion and leftward torsion will occur with the same probability.

However, in the case shown in FIGS. 4 and 5, since the projection 26 extends in the direction substantially perpendicular to the boundary B, the orientation of the liquid crystal molecules 3m existing in the transmissive display section 3A near the boundary B is substantially parallel to the boundary B, whereby the liquid crystal molecules 3m can be oriented at a desired angle.

Namely, the liquid crystal molecules 3m existing near the boundary B tend to be substantially parallel to the boundary B as a result of an excluded volume effect. On the other hand, in the transmissive display section 3A, the liquid crystal molecules 3m are oriented along the line of electric force 36 that is tilted from the substrate normal line because of the projection 26, i.e., oriented in the direction substantially parallel to the boundary B. Since the liquid crystal molecules are oriented in the same direction near the boundary B and near the projection 26, no orientational relaxation occurs and hence desired orientation can be realized.

By virtue of the above, in the liquid crystal display device of the embodiment, a wide viewing angle can be realized by reliable domain division, and high-quality transmissive display and reflective display can be realized, in which degradation in optical transmittance due to variations in orientation between the liquid crystal molecules 3m is suppressed.

In a liquid crystal display device according to the first embodiment, the counter substrate 2 has projecting portions 24 for changing the thickness of the liquid crystal layer, which is located below the counter electrode 25 opposing the reflective display section 3B of the liquid crystal layer 3, as shown in FIG. 4. In this embodiment, each projecting portion 24 has a thickness of about 1.8 μm.

The counter substrate 2 has a projection 26 serving as a control section and provided on the counter electrode 25 opposing the transmissive display section 3A. In the embodiment, the projection 26 extends in a direction substantially perpendicular to the boundary B, and has a thickness of about 1.2 μm.

The array substrate 1 has pixel electrodes 13 opposing the counter electrode 25 as shown in FIG. 5. Each pixel electrode 13 includes a transmissive electrode 41 opposing the transmissive display section 3A and reflective display section 3B, and a reflective electrode 40 provided on the transmissive electrode 41 and opposing the reflective display section 3B.

The liquid crystal display panel 100 comprises the counter substrate 2 and array substrate 1. The counter substrate 2 opposing the array substrate 1 is coated with an alignment film (not shown) with a thickness of 70 nm that exhibits a vertical property. Between the counter substrate 2 and array substrate 1, resin beads (not shown) with a diameter of 3.8 μm are provided as spacers. Further, the space defined by the spacers between the substrates 1 and 2 is filled with a liquid crystal material of negative anisotropic dielectric constant, thereby enabling transmissive display and reflective display.

In the first embodiment, the liquid crystal molecules 3m in the transmissive display section 3A are oriented substantially parallel to the boundary B as shown in FIG. 4. Namely, a wide viewing angle can be realized by reliable domain division, and high-quality transmissive display and reflective display can be realized, in which degradation in optical transmittance due to, for example, variations in orientation between the liquid crystal molecules 3m is suppressed.

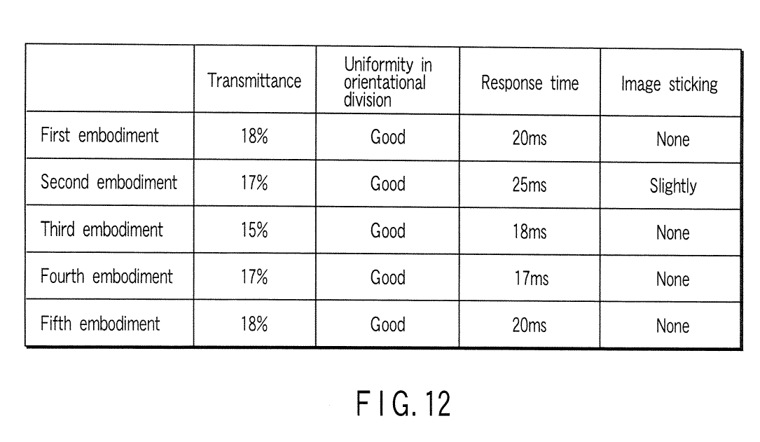

FIG. 12 shows estimation results concerning the transmittance and response time, acquired from liquid crystal display devices with the above-described liquid crystal display panel 100 actually produced. The response time indicates the sum of the time required until the brightness is shifted from 10% to 90% when the tone is switched from the minimum level to the maximum level, and the time required until the brightness is shifted from 90% to 10% when the tone is switched from the maximum level to the minimum level.

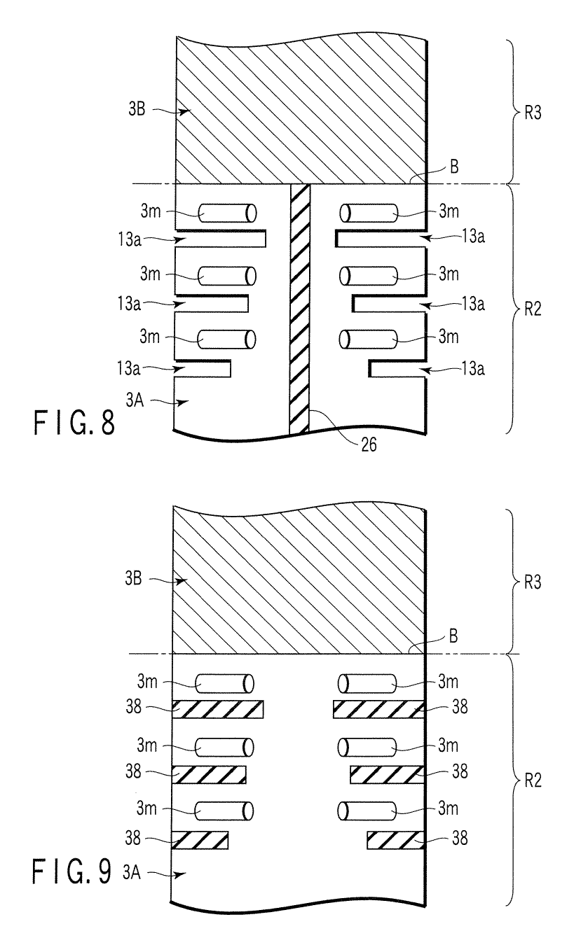

A description will be given of a liquid crystal display device according to a second embodiment of the invention. As shown in FIG. 8, the second embodiment differs from the first embodiment in each pixel electrode 13 on the array substrate 1.

The pixel electrode 13 has slits (cut portions) 13a serving as control sections. The slits 13a extend substantially parallel to the boundary B in opposite sides of the pixel electrode 13 that extends substantially perpendicularly to the boundary B. The closer to the boundary B, the longer the slit 13a, which enables the orientation of the liquid crystal molecules 3m near the boundary B to be controlled effectively. The counter substrate 2 has a projection 26 as in the first embodiment.

The liquid crystal display panel 100 of the second embodiment is similar to that of the first embodiment except for the structure of the pixel electrode 13, and can provide the same advantage as the first embodiment. Further, when using the slits 13a as control sections, they can be designed in each pixel relatively freely. This enables a preferable transmittance, response speed and viewing angle to be acquired relatively easily.

The estimation results concerning the transmittance and response time, acquired from the liquid crystal display device of the second embodiment, are shown in FIG. 12.

Also when dielectrics 38 used as control sections are formed on each pixel electrode 13 as shown in FIG. 9, the liquid crystal molecules existing in the entire transmissive display section 3A can be made substantially parallel to the boundary B. This structure will be described.

FIG. 9 shows a liquid crystal display device according to a third embodiment of the invention. As shown in FIG. 9, stripe-shaped dielectrics (insulation structures) 38 serving as control sections are provided on each pixel electrode 13 of the array substrate 1. Each dielectric 38 is provided on the pixel electrode 13 that extends substantially perpendicularly to the boundary B, and extends from opposite sides of the pixel electrode 13 substantially parallel to the boundary B. The closer to the boundary B, the longer the dielectric 38. This enables the orientation of the liquid crystal molecules 3m near the boundary B to be more effectively controlled as in the second embodiment.

The dielectrics 38 are formed of acrylic resin, epoxy resin, novolac resin, etc., which has a lower dielectric constant than the liquid crystal material. In particular, when regarding the liquid crystal layer transmittance as important, it is preferable to use a resin that can be subjected to microfabrication.

The liquid crystal display panel 100 of the third embodiment is similar to the first embodiment except for the structures of the pixel electrodes 13 and counter electrode 25, and can provide the same advantage as the first embodiment. The estimation results concerning the transmittance and response time, acquired from the liquid crystal display device of the third embodiment, are shown in FIG. 12.

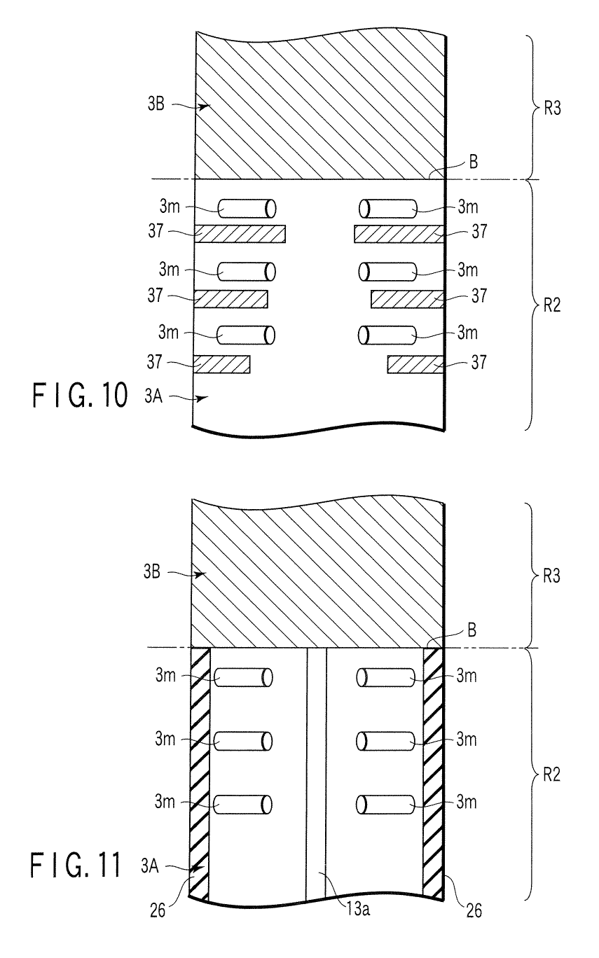

A liquid crystal display device according to a fourth embodiment of the invention will be described with reference to FIG. 10. As shown in FIG. 10, the array substrate 1 includes stripe-shaped recesses 37 formed below each pixel electrode 13 and serving as control sections. The recesses 37 extend, in a direction substantially parallel to the boundary B, from sides of each pixel electrode 13 that extends substantially perpendicular to the boundary B. The arrangement of the recesses 37 depends upon the undulatory structure of an insulation layer 90, in the transmissive region R2. The undulatory structure and uneven structure of the insulation layer 90 as the underlayer of the pixel electrodes 13 are formed at the same time.

Namely, the recesses 37 are defined by providing the pixel electrodes 13 on depressions formed in the insulation layer 90 as the underlayer of the electrodes 13 in the transmissive region R2. The closer to the boundary B, the longer the recess 37, which enables the orientation of the liquid crystal molecules 3m near the boundary B to be controlled more effectively, as in the second embodiment.

Further, in the reflective region R3, it is desirable to simultaneously form the recesses 37 and the uneven structure for diffusion reflecting the light guided from the counter substrate 2 side. The insulation layer 90 may be formed of an acrylic resin, epoxy resin, novolac resin, etc. The simultaneous forming of the recesses 37 and uneven structure enables the liquid crystal display device to be produced without increasing the number of production processes. By virtue of the above structure, a wide viewing angle can be realized by reliable domain division, and high-quality transmissive display and reflective display can be realized, in which degradation in optical transmittance due to variations in orientation between the liquid crystal molecules 3m is suppressed.

The liquid crystal display panel 100 of the fourth embodiment is similar to the first embodiment except for the structures of the pixel electrodes 13 and counter electrode 25, and can provide the same advantage as the first embodiment. The estimation results concerning the transmittance and response time, acquired from the liquid crystal display device of the fourth embodiment, are shown in FIG. 12.

A liquid crystal display device according to a fifth embodiment of the invention will be described with reference to FIG. 11. As shown in FIG. 11, projections 26 are provided on the counter electrode 25, and a slit 13a is formed in each pixel electrode, which serves as a lacking section of each pixel electrode. Specifically, the projections 26 are provided on the counter electrode 25 in the transmissive region R2 at positions opposing the sides of each pixel electrode 13 that extend substantially perpendicularly to the boundary B. The slit 13a extends between the projections 26 substantially perpendicularly to the boundary B in the transmissive region R2.

The liquid crystal display panel 100 of the fifth embodiment is similar to the first embodiment except for the structures of the pixel electrodes 13 and counter electrode 25, and can provide the same advantage as the first embodiment. The estimation results concerning the transmittance and response time, acquired from the liquid crystal display device of the fifth embodiment, are shown in FIG. 12.

By virtue of the structure shown in FIG. 12, a wide viewing angle can be realized by reliable domain division, and high-quality transmissive display and reflective display can be realized, in which degradation in optical transmittance due to variations in orientation between the liquid crystal molecules 3m is suppressed.

As described above in detail, the embodiments of the invention are characterized in that the orientation of the liquid crystal molecules near the boundary B in the transmissive display section 3A is substantially parallel to the boundary B. This structure provides a liquid crystal display device that has a wide viewing angle and can realize high-quality transmissive display and reflective display.

The invention is not limited to the above-described first to fifth embodiments, but can be modified in various ways without departing from the scope.

For instance, although in the embodiments, only the alignment film 14 is provided on the pixel electrodes 13, and only the alignment film 27 is provided on the counter electrode 25, insulation films may be provided on the electrodes, if necessary. In this case, as the insulation films, non-organic thin films, such as SiO₂, SIN_{X}, Al₂O₃ films, or organic thin films, such as polyimide, photoresist resin high-polymer liquid crystal film, may be used.

In the case where the insulation films are non-organic thin films, vapor deposition, sputtering, chemical vapor deposition (CVD) or solution coating can be utilized. In the case where the insulation films are organic thin films, a solution containing an organic substance or a precursor to the solution may be coated by spinner coating, screen-printing or roll coating, and then hardened by a hardening process, such as heating or light radiation. Alternatively, vapor deposition, sputtering, CVD, Langlumuir-Blodgett method may be utilized.

The TFT 11 can be formed of a lamination of a semiconductor layer, such as a-Si or p-Si, and a metal layer of Al, Mo, Cr, Cu or Ta, etc. The high/low intensity field of electricity as means for controlling the tilt of liquid crystal molecules 3m may be set using ITO that is the material of pixel electrodes 13, or using a metal wire (of Al, Mo, Cu) for applying a signal voltage.

Further, a liquid crystal material having positive anisotropic dielectric factor can be used as the liquid crystal. However, to effectively control the orientation and tilt of liquid crystal molecules, a VAN-mode liquid crystal display device, in which liquid crystal molecules of negative anisotropic dielectric constant are vertically aligned, is most preferable. In particular, in display devices in which contrast is regarded as important, the combination of the normal black setting of the VAN mode and the orientation division state of the present invention enables a high contrast of 500:1 or more and a bright screen due to high transmittance to be designed.

Although the above-described embodiments employ the projections 26 of the counter substrate 2 and the slits 13a are used as control sections, the combination of the projections 26 of the counter substrate 2 and another structure may be used as control sections. Namely, the projections 26 and dielectrics are used as control section. The projections 26 and recesses 37 are used as control section. Also in this case, the same advantage as that of the embodiments can be acquired.

A detailed description will now be given of a liquid crystal display device according to a sixth embodiment of the invention.

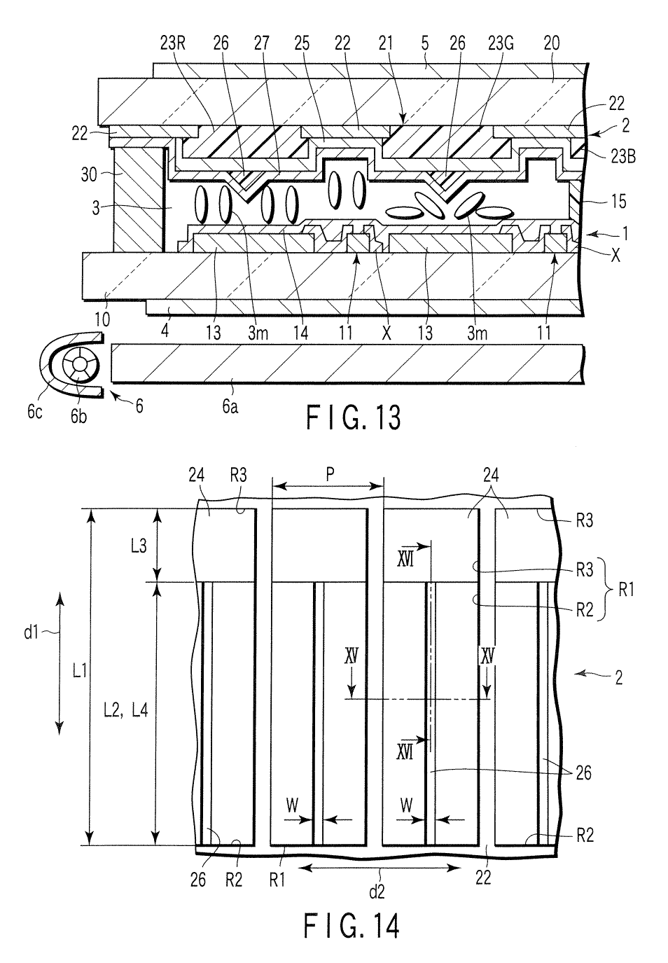

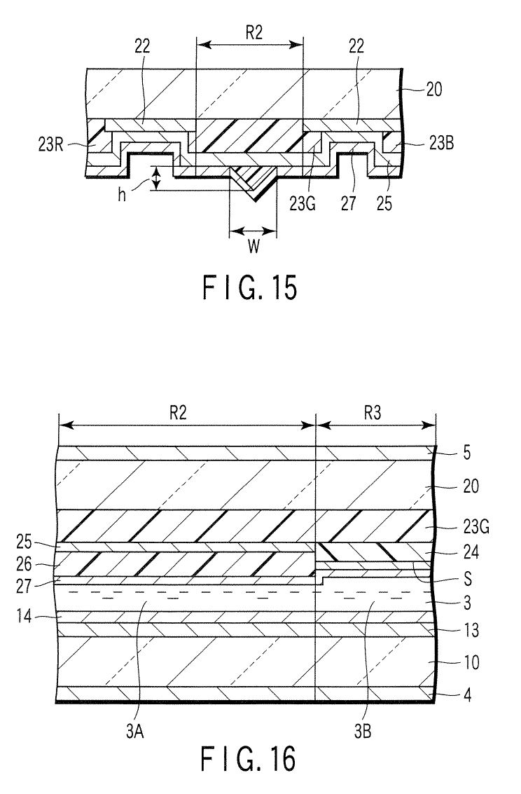

As shown in FIGS. 13, 14, 15 and 16, the liquid crystal display device comprises an array substrate 1, a counter substrate 2 arranged opposite to the array substrate 1 with a predetermind gap therebetween, and a liquid crystal layer 3 held between the array substrate 1 and counter substrate 2.

The array substrate 1 comprises a glass substrate 10 as a transparent insulating substrate. On the glass substrate 10, a plurality of signal lines X and a plurality of scanning lines (not shown) are provided. The signal lines X extend in a first direction d1, while the scanning lines extend in a second direction d2 perpendicular to the first direction. A plurality of pixel areas R1 defined by respective pairs of adjacent ones of signal lines and respective pairs of adjacent ones of scanning lines are arranged in a matrix, containing respective pixels formed therein. As will be described later in detail, each pixel area R1 is defined by corresponding pairs of signal lines and scanning lines, and is surrounded by a shade layer 22. Each pixel area R1 is a rectangular area having a long axis in the first direction d1. In this embodiment, the length L1 of the long axis of each pixel area R1 is 150 μm. In the second direction d2, the pixel areas R1 are arranged with a pitch P of 50 μm.

In the array substrate 1, each pixel comprises a TFT 11 having a semiconductor film of amorphous silicon or polysilicon, and a pixel electrode 13. Further, an alignment film 14 covering the pixel electrodes 13 is provided on the glass substrate 10. In this case, the alignment film 14 is a vertical alignment film. A plurality of columnar spacers 15 are provided on the alignment film 14. In this embodiment, the height of the spacers 15 is 2 μm.

The counter substrate 2 includes a glass substrate 20 as a transparent insulating substrate. On the glass substrate 20, there are provided shade layers 22 serving as a black matrix, and color filter 21 including red coloring layers 23R, green coloring layers 23G and blue coloring layers 23B. The periphery of each coloring layer is superposed by the shade layer 22. The pixel areas R1 surrounded by the shade layer 22 are arranged in a matrix.

A more detailed description will be given of the pixel area R1. The pixel area R1 opposes the counter substrate 2, and includes a rectangular transmissive region R2 and rectangular reflective region R3 adjacent thereto along the long axis of the pixel area R1. In this embodiment, the length L2 of the transmissive region R2 in the first direction d1 is 120 μm, and the length L3 of the reflective region R3 in the first direction d1 is 30 μm.

A plurality of projecting portions 24 are formed on the color filter 21 at positions corresponding to the reflective regions R3. The projecting portions 24 are formed of a photosensitive acrylic resin, and have a thickness of about 1 μm. Each projecting portion 24 imparts a step between the transmissive region R2 and reflective region R3. Each projecting portion 24 has a surface S that has small depressions and projections and opposes the array substrate 1.

A counter electrode 25 formed of a transparent conductive film, such as an ITO film, is provided on the color filter 21 and projecting portions 24. On the counter electrode 25, a plurality of stripe-shaped projections 26 serving as control sections are provided. More specifically, the projections 26 have a triangular section, and extend in the first direction d1 to divide the transmissive region R2 into two portions in the second direction d2.

Further, the width w of the projections 26 in the second direction d2 is 10 μm, and the height h of the projections 26 is 1.5 μm. Accordingly, the projections 26 project by 1.5 μm from the surface of the counter electrode 25 toward the array substrate 1. An alignment film 27, which is a vertical alignment film, is formed on the counter electrode 25 and projections 26.

The array substrate 1 and counter substrate 2 are bonded to each other by a sealing member 30 provided on the peripheries of the substrates, and are opposed to each other by the columnar spacers 15 with a preset gap interposed therebetween. The liquid crystal layer 3 is formed by filling, with liquid crystal, the space defined between the array substrate 1, counter substrate 2 and sealing member 30. The liquid crystal layer 3 includes a plurality of transmissive display sections 3A corresponding to the transmissive regions R2, and a plurality of reflective display sections 3B corresponding to the reflective regions R3.

The pixel electrode 13 will be described in more detail. The pixel electrode 13 has a transmissive electrode and reflective electrode, which are not shown. The transmissive electrode is formed of a transparent film of, for example, ITO (indium tin oxide), and is provided in the transmissive region R2. The reflective electrode has the function of reflecting the light received, and is formed of, for example, a metal and provided in the reflective region R3.

A first optical section 4 is provided on the outer surface of the array substrate 1, while a second optical section 5 is provided on the outer surface of the counter substrate 2. The first and second optical sections 4 and 5 have respective two-axis retardation plate (not shown) and polarizing plate. A backlight unit 6 is provided outside the first optical section 4 near the outer surface of the first optical section 4. The backlight unit 6 comprises a light guide 6a a light source 6b and reflector 6c. The light guide 6a is opposite to the first optical section 4 and includes a light guiding plate. The light source 6b and reflector 6c face one side of the light guide 6a. Thus, a multi-domain VA-mode transflective liquid crystal display device is provided.

The projection 26 employed in the sixth embodiment will be described in more detail.

### EXAMPLE 1

In example 1, the projection 26 is formed in the transmissive region R2 as shown in FIG. 16. The length L4 of the projection 26 in the first direction d1 is 120 μm, i.e., equal to the length L2 of the transmissive region R2 in the first direction d1. Accordingly, one end of the projection 26 is aligned with the edge of the projecting portion 24 close to the transmissive region R2. Thus, the distance between an end of the projection 26 and the edge of the projecting portion 24 is 0 μm.

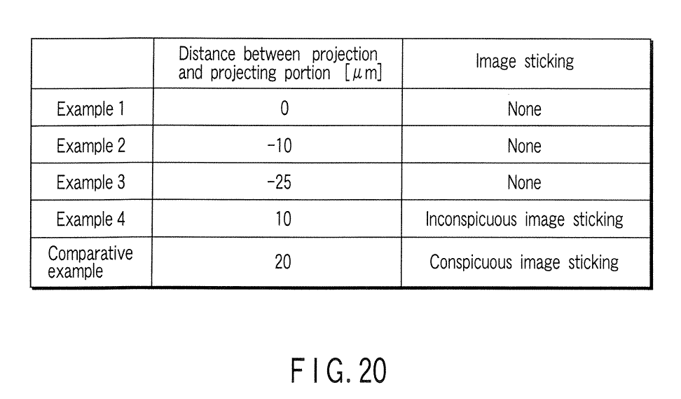

The inventors of the present invention have examined the display characteristics of the liquid crystal display device provided with the above-mentioned projections 26, and have found that the displayed images had no image sticking as shown in FIG. 20, and a high reflectance could be obtained.

### EXAMPLE 2

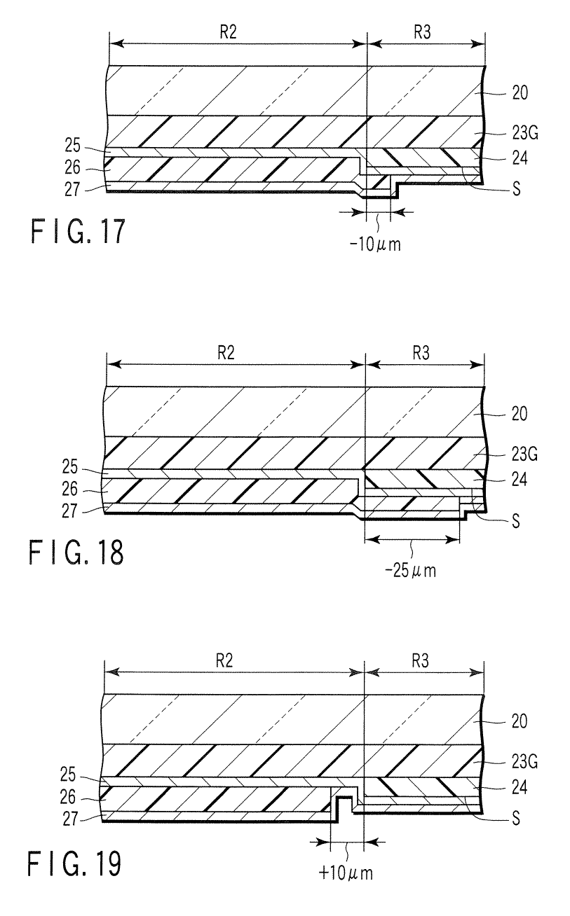

In example 2, the projection 26 extends in both the resistive region R2 and reflective region R3 as shown in FIG. 17. The length L4 of the projection 26 in the first direction d1 is 130 μm. Accordingly, one end of the projection 26 overlaps by 10 μm with the edge of the projecting portion 24 close to the transmissive region R2. Namely, the distance between the one end of the projection 26 and the edge of the projecting portion 24 is −10 μm.

The inventors of the present invention have examined the display characteristics of the liquid crystal display device provided with the above-mentioned projections 26, and have found that the displayed images had no image sticking as in example 1, as is shown in FIG. 20. Further, although the projection 26 overlaps with the projecting portion 24 by 10 μm, the reduction in reflectance is small and a high reflectance substantially equal to that of example 1 could be obtained. Note that if the overlapping range of the projection 26 and projecting portion 24 is 0 to 10 μm, a high reflectance substantially equal to that of example 1 can be obtained.

### EXAMPLE 3

In example 3, the projection 26 extends in both the resistive region R2 and reflective region R3 as shown in FIG. 18. The length L4 of the projection 26 in the first direction d1 is 145 μm. Accordingly, one end of the projection 26 overlaps by 25 μm with the edge of the projecting portion 24 close to the transmissive region R2. Namely, the distance between the one end of the projection 26 and the edge of the projecting portion 24 is −25 μm.

The inventors of the present invention have examined the display characteristics of the liquid crystal display device provided with the above-mentioned projections 26, and have found that the displayed images had no image sticking as in example 1, as is shown in FIG. 20. Since the projection 26 overlaps with the projecting portion 24 by 25 μm, a relatively high reflectance could be obtained although it was lower than that of Embodiment 1.

### EXAMPLE 4

In example 4, the projection 26 extends in the resistive region R2 as shown in FIG. 19. The length L4 of the projection 26 in the first direction d1 is 100 μm. One end of the projection 26 is located at a distance of 10 μm from the edge of the projecting portion 24 close to the transmissive region R2, and the other end (not shown) of the projection 26 is located at a distance of 10 μm from the other boundary of the transmission region R2.

The inventors of the present invention have examined the display characteristics of the liquid crystal display device provided with the above-mentioned projections 26, and have found that the displayed images had image sticking but only inconspicuous one as shown in FIG. 20. Further, a high reflectance substantially equal to that of example 1 could be obtained. When the distance between the projection 26 and the projecting portion 24 was more than 0 μm and less than 15 μm, image sticking but only inconspicuous one occurred.

### COMPARATIVE EXAMPLE

In a comparative, the projection 26 extends in the transmissive region R2. The length L4 of the projection 26 in the first direction d1 is 80 μm. One end of the projection 26 is located at a distance of 20 μm from the edge of the projecting portion 24 close to the transmissive region R2, and the other end (not shown) of the projection 26 is located at a distance of 20 μm from the other boundary of the transmission region R2.

The inventors of the present invention have examined the display characteristics of the liquid crystal display device provided with the comparative projections 26, and have found that the displayed images had conspicuous image sticking. Further, a high reflectance could be obtained as in example 1.

As described above, image sticking does not occur when one end of the projection 26 is aligned with the edge of the projecting portion 24 close to the transmissive region R2, or when the one end of the projection 26 overlaps with the edge of the projecting portion 24 close to the transmissive region R2. In other words, when the counter substrate 2 is viewed in a direction prependicular to its surface, if there is no gap between one end of the projection 26 and the edge of the projecting portion 24, image sticking does not occur. In this case, a liquid crystal display device of good appearance, high contrast and high display quality is provided.

In contrast, if there is a gap of 15 μm or more between one end of the projection 26 and the edge of the projecting portion 24 close to the transmissive region R2, the orientation of the liquid crystal molecules 3m near the gap is destabilized, thereby causing image sticking.

Since liquid crystal display devices employ multi-domain-type VA mode, image display of a wide viewing angle can be realized by transmissive display. The projecting section 24 has a surface S with small projections and depressions that opposes the array substrate 1, which enables image display of a wide viewing angle to be realized even by reflective display.

When the overlapping range of one end of the projection 26 and projecting portion 24 close to the transmissive region R2 is 0 to 10 μm, and when there is a gap between one end of the projection 26 and the edge of the projecting portion 24 close to the transmissive region, a high reflectance can be obtained. Accordingly, if reflective display using external light is performed in a bright place, such as outdoors, image display of high visibility can be realized.

In light of the above, it is desirable to cause one end of the projection 26 to be separate by 10 μm or less from the edge of the projecting portion 24 close to the transmissive region R2, to cause the one end of the projection 26 to overlap by 10 μm with that edge of the projecting portion 24 close to the transmissive region R2, thereby suppressing the reduction of reflectance, and making image sticking inconspicuous. It is more desirable to cause the one end of the projection 26 to be aligned with that edge of the projecting portion 24 close to the transmissive region, or to cause the one end of the projection 26 to overlap by 10 μm with that edge of the projecting portion 24, thereby completely eliminating image sticking.

The invention is not limited to the above-described sixth embodiment, and may be modified in various ways without departing from the scope. For instance, the cross section of the projection 26 is not limited to a triangle, but may be an arbitrary polygon or semicircle. Further, the height of the projection 26 is not limited to 1.5 μm. If it is not less than 1 μm, the same advantage as that of the embodiments can be obtained. Further, even if the projection 26 is divided into a plurality of portions in the first direction d1, the same advantage can be obtained. The pitch P of the pixel regions R1 is not limited to 50 μm. If the pitch is about 20 to 100 μm, the same advantage as the above can be obtained. The projecting portions 24 and projections 26 may be incorporated in the array substrate 1 instead.

Moreover, various inventions can be realized by appropriately combining the structure elements disclosed in the embodiments. For instance, some of the disclosed structural elements may be deleted. Some structural elements of different embodiments may be combined appropriately.

What is claimed is:

1. A liquid crystal display device comprising:
a first electrode substrate;
a second electrode substrate arranged opposite to the first electrode substrate with a gap therebetween;
a liquid crystal layer held between the first and second electrode substrates, and including transmissive display sections and reflective display sections adjacent to the transmissive display sections, a linear boundary being defined between each transmissive display section and each reflective display section, orientation of liquid crystal molecules in the transmissive display sections and the reflective display sections being controlled in accordance with voltages applied to the liquid crystal layer by the first and second electrode substrates; and
a control section which controls an electric field generated by the applied voltages to set, substantially parallel to the boundary, the orientation of the liquid crystal molecules which exist in the transmissive display sections near the boundary.

2. The liquid crystal display device according to claim 1, wherein the control section is provided in at least one of the first and second electrode substrates.

3. The liquid crystal display device according to claim 1, wherein:
the first electrode substrate includes pixel electrodes;
the second electrode substrate includes a counter electrode; and
the control section includes an insulating structures provided on at least one of the pixel electrodes and the counter electrode.

4. The liquid crystal display device according to claim 1, wherein
the first electrode substrate includes pixel electrodes which apply a voltage to the liquid crystal layer; and
the control section includes cut portions incorporated in the pixel electrodes.

5. The liquid crystal display device according to claim 4, wherein:
the second electrode substrate includes a counter electrode opposing the pixel electrode; and
the control section further includes insulating structures provided on the counter electrode.

6. The liquid crystal display device according to claim 1, wherein:
the first electrode substrate includes pixel electrodes which apply a voltage to the liquid crystal layer;
each pixel electrode includes a reflective electrode and a transmissive electrode, the reflective electrode being provided in the reflective display section and configured to reflect, to the second electrode substrate, light guided through the second electrode substrate, the transmissive electrode being provided in the transmissive display section and configured to transmit, to the second electrode substrate, light guided through the firsts electrode substrate; and
the control section includes recesses provided in the transmissive electrodes.

7. The liquid crystal display device according to claim 6, wherein the recesses are defined by an uneven surface of an insulating layer which is provided on the first electrode substrate and serves as an underlayer of the transmissive electrodes and the reflective electrodes.

8. The liquid crystal display device according to claim 1, wherein the liquid crystal layer is formed of a liquid crystal material of negative anisotropic dielectric constant.

9. The liquid crystal display device according to claim 8, wherein the first and second electrode substrates include respective vertical alignment films, and the liquid crystal layer is of a vertical aligned type in which the liquid crystal molecules are vertically oriented.

10. The liquid crystal display device according to claim 1, further comprising projecting portions which are provided on the second electrode substrate at positions corresponding to the reflective display sections and project toward the first electrode substrate to make the reflective display sections thinner than the transmissive display sections,
and wherein the control section includes projections which are provided on the second electrode substrate at positions corresponding to the transmissive display sections and projects toward the first electrode substrate to control the orientation of the liquid crystal molecules of the transmissive display sections,
each projection including an end aligned with an edge of each projecting portion which contacts each transmissive display section.

11. The liquid crystal display device according to claim 1, further comprising a projecting portions which are provided on the second electrode substrate at positions corresponding to the reflective display sections and project toward the first electrode substrate to make the reflective display section thinner than the transmissive display section,
and wherein the control section includes projections which are provided on the second electrode substrate at positions corresponding to the transmissive display sections and projects toward the first electrode substrate to control the orientation of the liquid crystal molecules of the transmissive display sections,
each projection including an end overlapping with an edge of each projecting portion which contacts each transmissive display section.

12. The liquid crystal display device according to claim 10, wherein each projection projects by not less than 1 μm toward the first electrode substrate.

13. The liquid crystal display device according to claim 11, wherein each projection projects by not less than 1 μm toward the first electrode substrate.

14. The liquid crystal display device according to claim 10, wherein each projection is in a form of a stripe-shaped and extends perpendicularly to the boundary.

15. The liquid crystal display device according to claim 11, wherein each projection is in a form of a stripe-shaped and extends perpendicularly to the boundary.

16. The liquid crystal display device according to claim 10, wherein each projecting portion has an uneven surface opposing the first electrode substrate.

17. The liquid crystal display device according to claim 11, wherein each projecting portion has an uneven surface opposing the first electrode substrate.

18. A liquid crystal display device comprising:
a first electrode substrate;
a second electrode substrate arranged opposite to the first electrode substrate with a gap therebetween;
a liquid crystal layer held between the first and second electrode substrates and including transmissive display sections and reflective display sections adjacent to the transmissive display sections, orientation of liquid crystal molecules in the transmissive display sections and the reflective display sections being controlled in accordance with voltages applied to the liquid crystal layer by the first and second electrode substrates;
projecting portions provided on the second electrode substrate at positions corresponding to the reflective display sections, and projecting toward the first electrode substrate to make the reflective display sections thinner than the transmissive display sections; and
projections provided on the second electrode substrate at positions corresponding to the transmissive display sections, and projecting toward the first electrode substrate to control the orientation of the liquid crystal molecules of the transmissive display sections, each projection including an end located at a gap from an edge of the projecting portion adjacent to the transmissive display section.

19. A liquid crystal display device comprising:
a first electrode substrate;
a second electrode substrate arranged opposite to the first electrode substrate with a gap therebetween;
a liquid crystal layer held between the first and second electrode substrates and including transmissive display sections and reflective display sections adjacent to the transmissive display sections, orientation of liquid crystal molecules in the transmissive display sections and the reflective display sections being controlled in accordance with voltages applied to the liquid crystal layer by the first and second electrode substrates;
projecting portions provided on the second electrode substrate at positions corresponding to the reflective display sections, and projecting toward the first electrode substrate to make the reflective display sections thinner than the transmissive display sections; and
projections provided on the second electrode substrate at positions corresponding to the transmissive display sections, and projecting toward the first electrode substrate to control the orientation of the liquid crystal molecules of the transmissive display sections, each projection including an end aligned with an edge of the projecting portion adjacent to the transmissive display section.
